(19) United States
(12) Patent Application Publication
(10) Pub. No.: US 2026/0303515 A1
(43) Pub. Date: Oct. 1, 2026

(54) NETWORK DEVICE WITH ADAPTABLE FORWARDING BEHAVIOR

(71) Applicant: Amazon Technologies, Inc., Seattle, WA (US)

(72) Inventors: James Paul RIVERS, Capitola, CA (US); Mark KAMICHOFF, Ashburn, VA (US); Stephen CALLAGHAN, Seattle, WA (US); Sharjeel Nasar KANGASANI, Duvall, WA (US); Yury SHEFER, REDONDO BEACH, CA (US); Karthick MURUGAN, Dublin, CA (US); Alber Edmon Abdelshahid MOINES, Dun Laoghaire (IE)

(73) Assignee: Amazon Technologies, Inc., Seattle, WA (US)

(21) Appl. No.: 19/095,429

(22) Filed: Mar. 31, 2025

(51) Int. Cl. H04L 45/00; H04L 45/28

(52) U.S. Cl. CPC H04L 45/22; H04L 45/28

(57) ABSTRACT

A network device is described that offers advanced traffic management and failure handling mechanisms to address AI/ML networking challenges. The network device includes an adaptive rail mapping that allows GPUs on different server computers in different parts of a network to communicate efficiently. Additionally, such communication between the GPUs is not disrupted in the face of failures. In one embodiment, the network device includes multiple forwarding modes wherein network traffic can proceed through different permutations of layers 1, 2, and 3 hardware. For example, the network device can dynamically change which layers of hardware that network packets travel through. Additionally, the network device can change a layer 1 mapping such that an input-port-to-output-port mapping can be reconfigured dynamically (without restarting the network device). Accordingly, the network device can route network traffic based upon a forwarding mode, which represents a desired data flow through the network fabric, and real-time network connectivity.

### BACKGROUND

Computer networks need to be optimized to support the growing demands of high-bandwidth applications, such as artificial intelligence (AI) applications and machine learning (ML) models. AI/ML models are becoming more complex requiring vast amounts of data and computational power. Cloud infrastructures can be used for AI models and provide specialized hardware, like Graphics Processing Units (GPUs) and Tensor Processing Units (TPUs), to handle AI workloads efficiently. Nonetheless, traditional network architectures suffer from latency, congestion, unbalanced utilization and flow interference. Additionally, optimized AI-specific network structures hamper workloads with disruptions from link flaps, switch failures, upgrades and network scaling activities.

Advanced network traffic management with failure handling mechanisms are needed to address AI/ML and other high-bandwidth networking challenges.

### BRIEF DESCRIPTION OF THE DRAWINGS

FIG. 1 is a system diagram showing a network device configured to optimize a Machine Learning (ML) accelerator.

FIG. 2 shows the network device of FIG. 1, wherein dynamic port remapping occurs while network traffic is being transmitted.

FIG. 3 is an example of a network device having adaptable forwarding behavior.

FIG. 4 shows another example of a network device having adaptable forwarding behavior.

FIG. 5 is an example system diagram showing a plurality of virtual machine instances running in the multi-tenant environment, with a central server computer that can control the dynamic port remapping of FIG. 2.

FIG. 6 shows an example of the network device of FIGS. 3 or 4 in a data center environment.

FIG. 7 is a flowchart according to one embodiment for adapting forwarding behavior in a network device.

FIG. 8 is a flowchart according to another embodiment for adapting forwarding behavior in a network device.

FIG. 9 depicts a generalized example of a suitable computing environment in which the described innovations may be implemented.

### DETAILED DESCRIPTION

A network device, such as a top-of-rack (TOR) switch, is described that offers advanced traffic management and failure handling mechanisms to address AI/ML networking challenges. The network device includes an adaptive rail mapping that allows GPUs, or other Integrated Circuits, on different server computers in different parts of a network to communicate efficiently. Additionally, such communication between the GPUs is not disrupted in the face of failures. In one embodiment, the network device includes multiple forwarding modes wherein network traffic can proceed through different permutations of layers 1, 2 and 3 hardware. For example, the network device can dynamically change which layers of hardware that network packets travel through. Additionally, the network device can change layer 1 mapping such that an input-port-to-output-port mapping can be reconfigured dynamically (without restarting the network device). Accordingly, the network device can dynamically adapt based upon a forwarding mode, which represents a desired data flow through the network fabric, and real-time network connectivity.

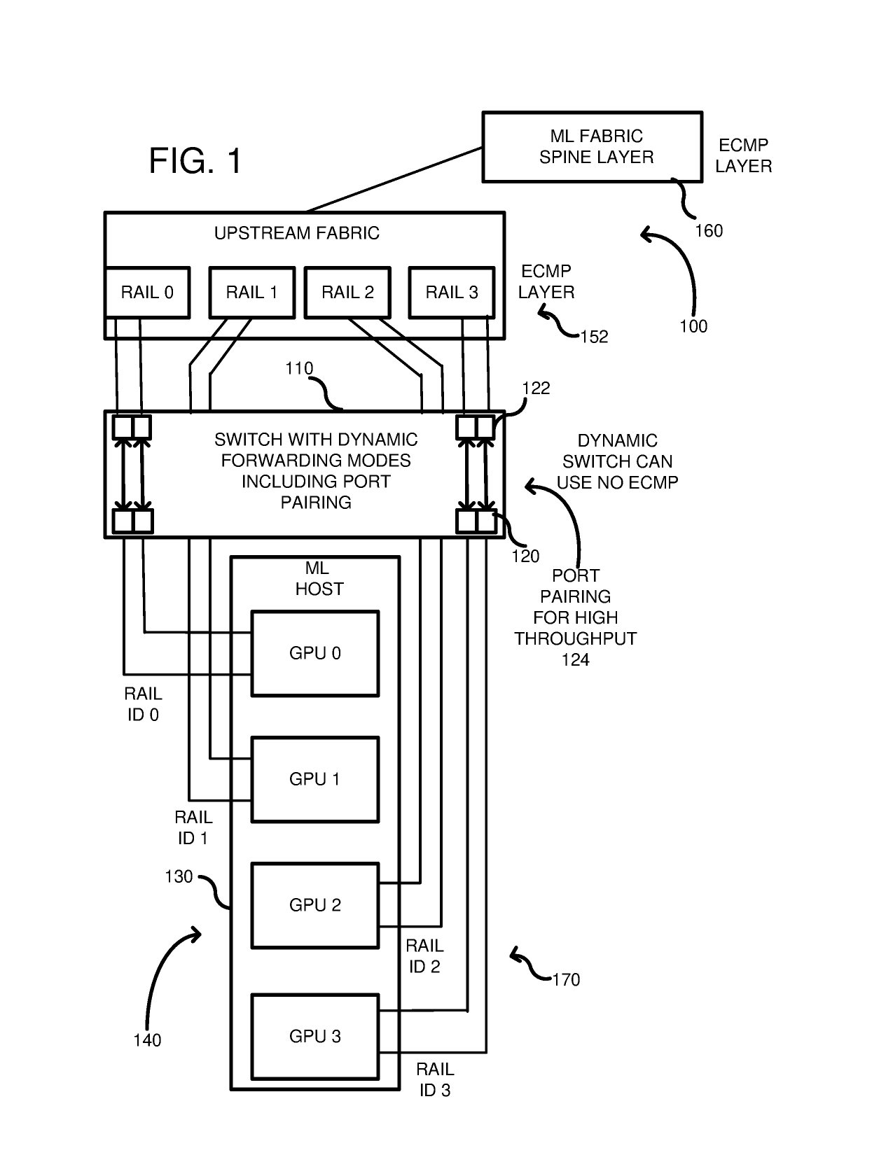

FIG. 1 shows a network 100 optimized for ML acceleration including reducing latency to minimize flow collisions. Flow collisions can result in congestion, buffer usage and queuing, which can result in packet loss. Additionally, the flow collisions impact bus bandwidth, which increases a time that GPUs are idle and have to wait for a collective operation to complete. In order to reduce flow collisions, a switch 110 is provided with dynamic forwarding modes including port pairing. In port pairing, the dynamic switch 110 performs layer 1 switching wherein a port 120 is assigned to a port 122 without requiring a layer 2 lookup or a layer 3 lookup. The paired ports 120, 122 provide low latency packet delivery to avoid Equal Cost Multi-Path (ECMP) behavior, hash collisions and incast. Using paired ports 124, such as ports 120, 122, an ML host 130 can operate efficiently by having multiple GPUs 140, such as GPU 0, GPU 1, GPU 2 and GPU 3, communicate to upper layers of the network 100 through rail connections. A rail is a dedicated network path through various layers of a network to connect network components together. For example, outputs of the GPU 0 are coupled to the switch 110, which uses the port pairing 124 to generate a rail to an upstream fabric 150, which includes a plurality of rails 152 as shown by rail 0, rail 1, rail 2 and rail 4. In one example, the rails allow a GPU 0 on one server rack to be connected to a GPU 0 on another server rack without being slowed by routing protocols, such as ECMP. Generally, additional rails are included in the switch but are not shown for simplicity and ease of illustration. Each rail is dedicated to one of the GPUs 140 and allows a high-speed connection through the switch 110 without requiring ECMP to be switched to the upstream fabric 152. The upstream fabric 152 can be an ECMP layer that includes groups of switches and is coupled to an ML fabric spine layer 160, which can also be an ECMP layer. The ML host 130 can be a portion (e.g., a node) of an ML model and the ML fabric spine layer 160 can couple each rail 152 to a rail on a different node (not shown) such that a GPU 0 (not shown) on a different node can communicate efficiently with GPU 0 within the ML host 130. Each GPU 140 has a unique rail ID, shown generically at 170. For example, GPU 0 is associated with rail ID 0, GPU 1 with rail ID 1, etc. The GPUs 140 can direct the switch 110 which rail it wants to be associated by sending a command to the switch 110 including the rail ID 170. The GPUs 140 may send this signal through respective network interface cards (NICs) (not shown) to which the GPUs are coupled. Thus, the GPUs 140 in the ML host 130 can control a switching configuration in the switch 110 upstream of the ML host. In one example, the GPUs 140 can control dynamic switching of the switch using reachability information (which destinations are reachable through which ports).

The switch 110 can also switch forwarding behavior including switching forwarding modes based upon a desired dataflow through the fabric, an operational state of the fabric and the connectivity of the switch 110. In particular, the switch 110 can switch from a forwarding mode that includes ECMP to the port pairing 124 and vice versa. Additionally, the switch 110 can monitor for connectivity issues and dynamically change port pairings to ensure that data continues to flow despite the connectivity issue. By dynamically changing a forwarding mode of network traffic, the switch 110 does not need to be powered down or restarted. Rather, network packets can continue to be transmitted through the switch 110. For example, if a port pairing associated with rail 0 is re-assigned due to a connectivity issue, network traffic can continue on the other rails of the switch 110. Although GPUs are generally described, other ICs can be used in place of the GPUs, such as ML accelerators.

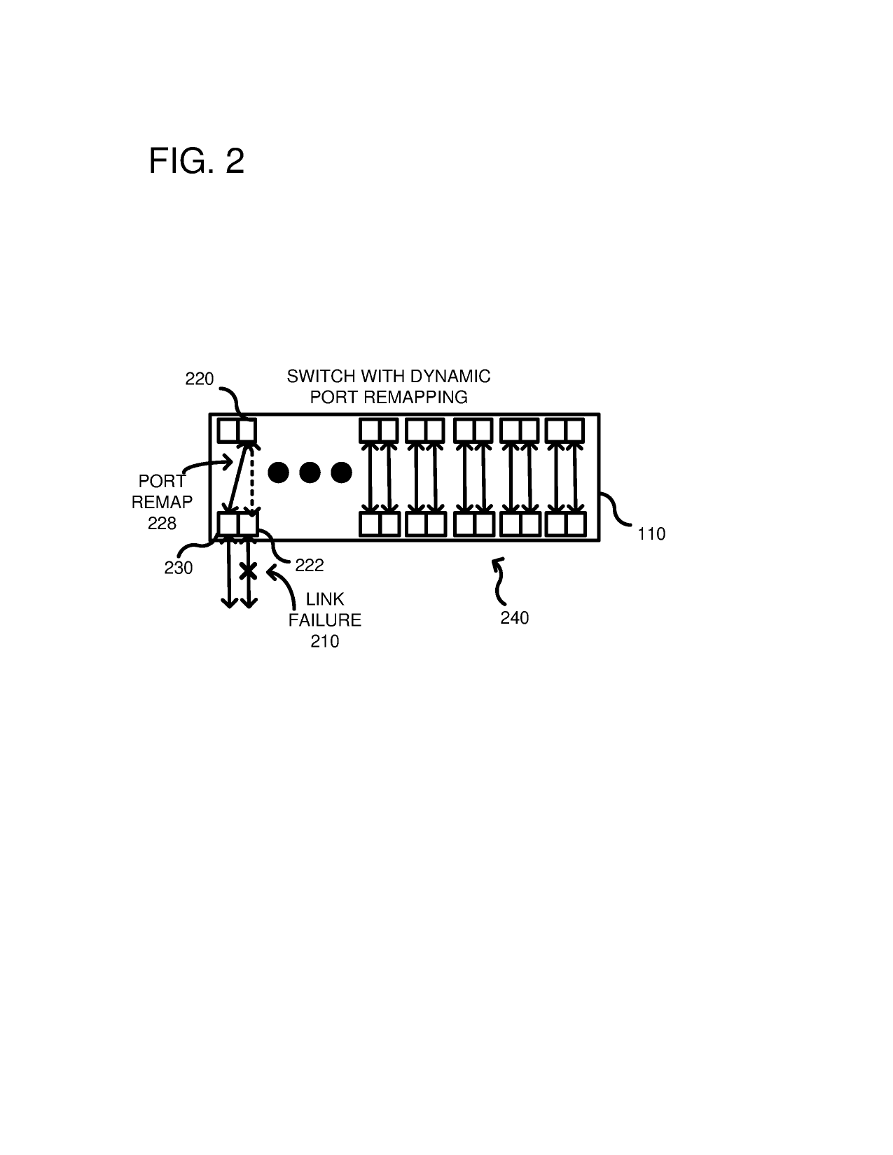

FIG. 2 shows the switch 110 that can dynamically be reconfigured due to, for example, a link failure 210. As shown in dashed lines, an input port 220 is assigned to an output port 222, which is associated with the link failure 210. As described further below in greater detail, the switch 110 can detect the link failure and dynamically remap 228 the assignment of input port 220 to output port 230. The dynamic remapping of ports 228 allows data to continue to flow with minimal interruption. Other port assignments 240 can continuously transmit network packets while the port remapping 228 occurs.

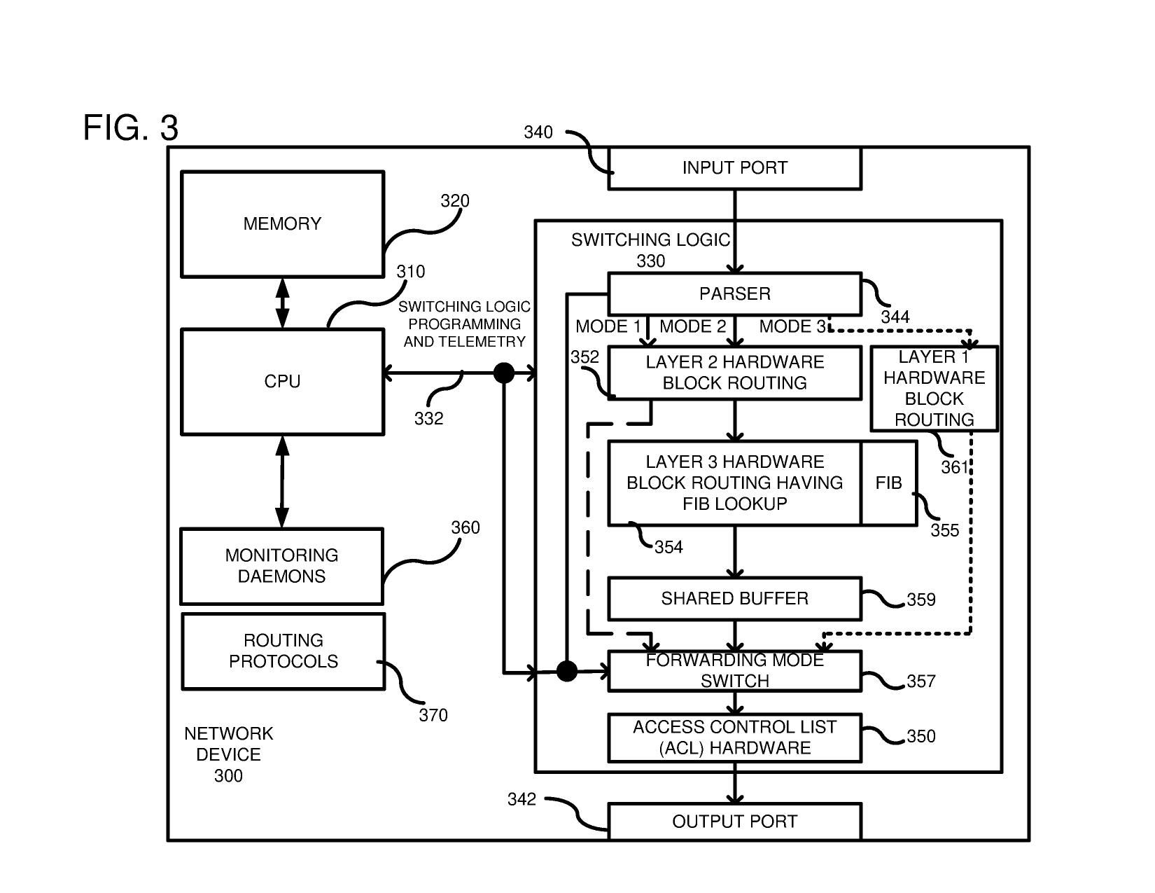

FIG. 3 shows a detailed example of an embodiment of a network device 300, which can be used as the switch 110 of FIG. 1. The network device 300 is a switch that routes packets to a next hop in the network using a destination IP address. However, network devices can include different types of switches (multilayer or single-layer), routers, repeaters, gateways, network bridges, hubs, protocol converters, bridge routers, proxy servers, firewalls, network address translators, multiplexers, network interface controllers, wireless network interface controllers, modems, ISDN terminal adapters, line drivers, and wireless access points, for example. In sum, a network device can also include any device used for forwarding packet data through the network 110. A CPU 310 is coupled to a memory 320 and to switching logic 330 through a bus 332 (PCIe or other protocols and bus types can be used). The switching logic 330 is positioned between an input port 340 and an output port 342, which are typically adapted to receive network cables, such as Ethernet cables, which are links between network devices. The input port 340 and output port 342 represent multiple input ports and output ports, although only one of each is shown for simplicity. The switching logic 330 can be a single ASIC integrated circuit or divided into multiple integrated circuits. The switching logic 330 can include multiple different hardware logic blocks including a parser 344, a Layer 2 hardware block 352, a Layer 3 hardware block 354, and an Access Control List (ACL) hardware block 350. The parser 344 identifies the header information in a network packet. The layer 2 hardware block 352 relates to an Ethernet layer and can forward packets based on MAC tables. The layer 3 hardware block 354 relates to forwarding based on a longest prefix match of an IP address. Layer 3 typically involves a route lookup, decrementing the TTL count, calculating a checksum, and forwarding the packet with the appropriate MAC header to the correct output port. The route lookup of the layer 3 hardware can include searching within a Forwarding Information Base (FIB) 355, which includes destination addresses for packets being transmitted through the switching logic. The network device can run routing protocols, such as an Open Shortest Path First (OSPF) or a Routing Information Protocol (RIP), to communicate with other Layer 3 switches or routers. The routing tables are used to lookup the route for an incoming packet. A shared buffer 359 is coupled to an output of the layer 3 hardware block 354. The ACL block 350 relates to permissions and can include rules whether to drop packets. A layer 1 hardware block 361 bypasses both the layer 2 hardware block 352 and the layer 3 hardware block 354. The layer 1 hardware block 361 can be programmed to make a connection between an input port 340 and an output port 342 without the lookups and ECMP processing of the layer 2 hardware block 352 and the layer 3 hardware block 354. In this sense, the layer 1 hardware block is coupled in parallel with the other hardware blocks 352, 354.

The different hardware blocks can be coupled in series and additional hardware blocks can be added based on the design. The series coupling of various hardware blocks in the switching logic is called a pipeline. Packets pass from the input port 340 to the output port in accordance with the configuration of the hardware logic blocks 344, 350, 352, 354. Prior to the ACL block 350 is a forwarding mode switch 357, which receives three different data paths representing mode 1, mode 2 and mode 3 and allows only the corresponding data path to pass therethrough depending on the mode.

In mode 1, network packets pass from the parser 344, through the layer 2 hardware block 352 and bypass the layer 3 hardware. In mode 2, the network packets pass through the parser 344, the layer 2 hardware block 352, the layer 3 hardware block 354, and the shared buffer 359. In mode 3, the network packets pass to a layer 1 hardware block 361 that bypasses both the layer 2 hardware block 352 and the layer 3 hardware block 354. The layer 1 hardware block 361 can be programmed to pair an input port with an output port, similar to what is shown in FIG. 1 at 124. Regardless of the mode, the ACL hardware block 350 can be included in the pipeline as it is positioned after the forwarding mode switch 357.

As shown, a monitoring daemon 360 can execute on the CPU 310 and can be used to monitor for link failures that can occur on the input port 340 or output port 342. Once a link failure is detected, the monitoring daemon 360 can re-assign the input/output port pairing as was shown in FIG. 2 (port remapping 228). The CPU 310 is coupled to the switching logic 330 and particularly can be coupled to the forwarding mode switch 357 to dynamically switch forwarding modes by allowing one of the inputs to the forwarding mode switch 357 to pass to the output. The parser 344 can also analyze a protocol being used by packets received at the input port 340 and switch the mode in the forwarding switch depending upon the protocol. For example, routing protocols and the associated forwarding modes can be stored at 370 and the parser can control how the packets are forwarded based upon the particular protocol found in the packet header. Additionally, the dynamic switching can be controlled by the parser 344 based upon reachability specific destinations. For example, the switching can be based upon which port can be used to reach a destination or use ECMP to broadcast to all ports. In any event, the network packets are processed through the switch using any of the available forwarding modes. And the parser 344 can make a packet-by-packet decision which forwarding mode to use. A decision tree of how the parser 344 dynamically switches can be programmed into the forwarding mode switch 357 by the CPU 310.

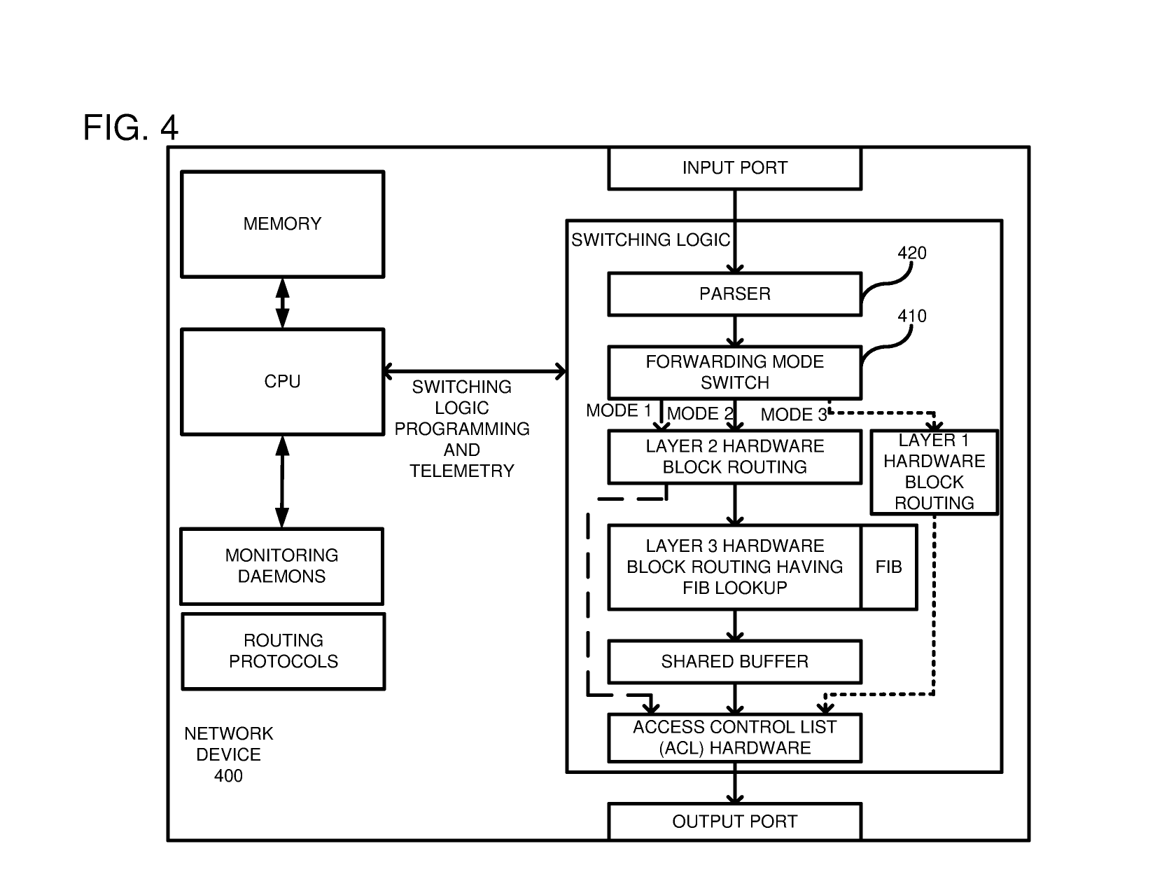

FIG. 4 is an alternative embodiment of a network device 400 that can be used. The components of FIG. 4 are substantially similar to FIG. 3 and like components are not re-described for simplicity. However, a difference between FIGS. 3 and 4 is a location of the forwarding mode switch 410, which is placed after a parser 420. In FIG. 3, the network packet traversed 3 different paths in parallel and the forwarding mode switch 357 selected the desired result. By contrast, in FIG. 4, the network packets only traverse one of the 3 paths as selected by the forwarding mode switch 410. Thus, different hardware designs can be used to allow for dynamically changing forwarding modes in the network device 400.

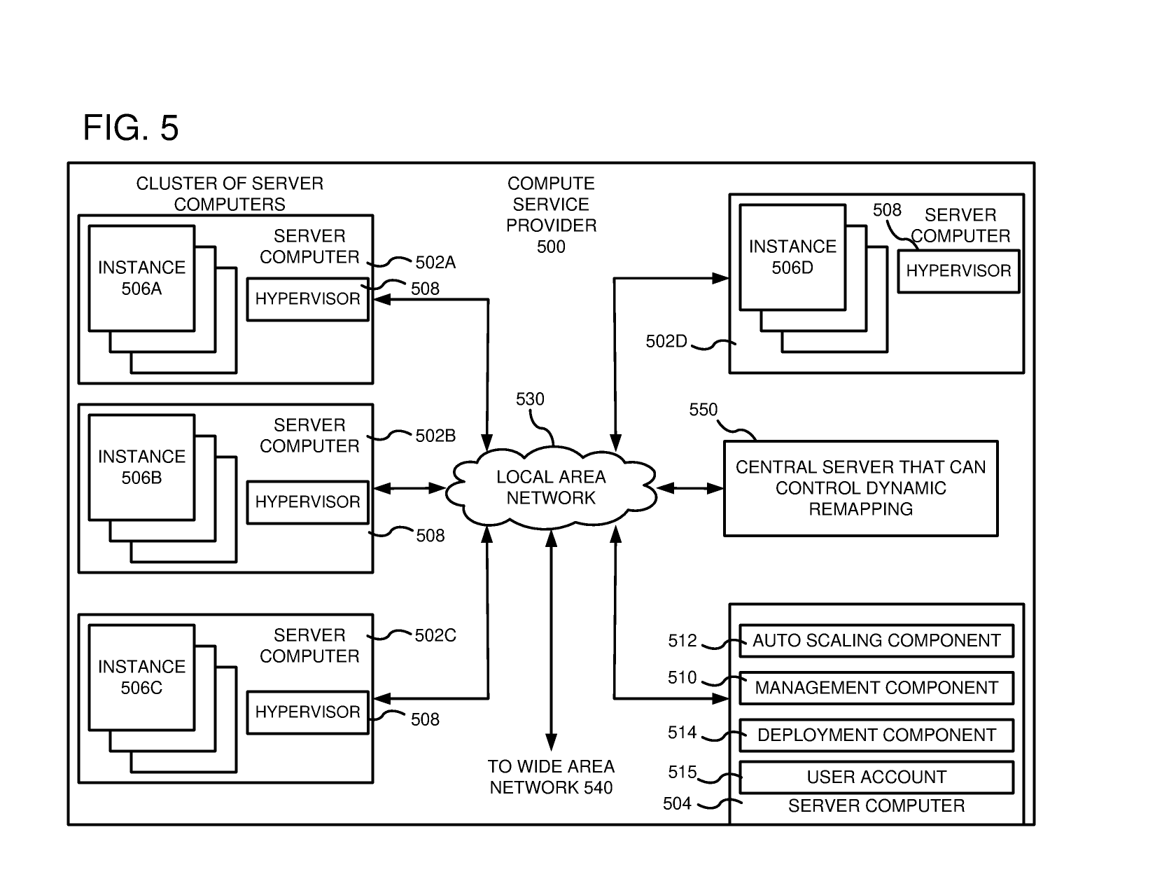

FIG. 5 is a computing system diagram of a network-based compute service provider 500 that illustrates one environment in which embodiments described herein can be used. By way of background, the compute service provider 400 (i.e., the cloud provider) is capable of delivery of computing and storage capacity as a service to a community of end recipients. In an example embodiment, the compute service provider can be established for an organization by or on behalf of the organization. That is, the compute service provider 500 may offer a “private cloud environment.” In another embodiment, the compute service provider 500 supports a multi-tenant environment, wherein a plurality of users operate independently (e.g., a public cloud environment). Generally speaking, the compute service provider 500 can provide the following models: Infrastructure as a Service (“IaaS”), Platform as a Service (“PaaS”), and/or Software as a Service (“SaaS”). Other models can be provided. For the IaaS model, the compute service provider 500 can offer computers as physical or virtual machines and other resources. The virtual machines can be run as guests by a hypervisor, as described further below. The PaaS model delivers a computing platform that can include an operating system, programming language execution environment, database, and web server. Application developers can develop and run their software solutions on the compute service provider platform without the cost of buying and managing the underlying hardware and software. The SaaS model allows installation and operation of application software in the compute service provider. In some embodiments, end users access the compute service provider 500 using networked client devices, such as desktop computers, laptops, tablets, smartphones, etc. running web browsers or other lightweight client applications. Those skilled in the art will recognize that the compute service provider 500 can be described as providing a “cloud” environment.

In some implementations of the disclosed technology, the computer service provider 500 can provide a cloud provider network. A cloud provider network (sometimes referred to simply as a "cloud") refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to user commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

With cloud computing, instead of buying, owning, and maintaining their own data centers and servers, organizations can acquire technology such as compute power, storage, databases, and other services on an as-needed basis. The cloud provider network can provide on-demand, scalable computing platforms to users through a network, for example allowing users to have at their disposal scalable “virtual computing devices” via their use of the compute servers and block store servers. These virtual computing devices have attributes of a personal computing device including hardware (various types of processors, local memory, random access memory (“RAM”), hard-disk and/or solid state drive (“SSD”) storage), a choice of operating systems, networking capabilities, and pre-loaded application software. Each virtual computing device may also virtualize its console input and output (“I/O”) (e.g., keyboard, display, and mouse). This virtualization allows users to connect to their virtual computing device using a computer application such as a browser, application programming interface, software development kit, or the like, in order to configure and use their virtual computing device just as they would a personal computing device. Unlike personal computing devices, which possess a fixed quantity of hardware resources available to the user, the hardware associated with the virtual computing devices can be scaled up or down depending upon the resources the user requires. Users can choose to deploy their virtual computing systems to provide network-based services for their own use and/or for use by their users or clients.

A cloud provider network can be formed as a number of regions, where a region is a separate geographical area in which the cloud provider clusters data centers. Each region can include two or more availability zones connected to one another via a private high speed network, for example a fiber communication connection. An availability zone (also known as an availability domain, or simply a “zone”) refers to an isolated failure domain including one or more data center facilities with separate power, separate networking, and separate cooling from those in another availability zone. A data center refers to a physical building or enclosure that houses and provides power and cooling to servers of the cloud provider network. Preferably, availability zones within a region are positioned far enough away from one other that the same natural disaster should not take more than one availability zone offline at the same time. Users can connect to availability zones of the cloud provider network via a publicly accessible network (e.g., the Internet, a cellular communication network) by way of a transit center (TC). TCs are the primary backbone locations linking users to the cloud provider network, and may be collocated at other network provider facilities (e.g., Internet service providers, telecommunications providers) and securely connected (e.g. via a VPN or direct connection) to the availability zones. Each region can operate two or more TCs for redundancy. Regions are connected to a global network which includes private networking infrastructure (e.g., fiber connections controlled by the cloud provider) connecting each region to at least one other region. The cloud provider network may deliver content from points of presence outside of, but networked with, these regions by way of edge locations and regional edge cache servers. This compartmentalization and geographic distribution of computing hardware enables the cloud provider network to provide low-latency resource access to users on a global scale with a high degree of fault tolerance and stability.

The cloud provider network may implement various computing resources or services that implement the disclosed techniques for TLS session management, which may include an elastic compute cloud service (referred to in various implementations as an elastic compute service, a virtual machines service, a computing cloud service, a compute engine, or a cloud compute service), data processing service(s) (e.g., map reduce, data flow, and/or other large scale data processing techniques), data storage services (e.g., object storage services, block-based storage services, or data warehouse storage services) and/or any other type of network based services (which may include various other types of storage, processing, analysis, communication, event handling, visualization, and security services not illustrated). The resources required to support the operations of such services (e.g., compute and storage resources) may be provisioned in an account associated with the cloud provider, in contrast to resources requested by users of the cloud provider network, which may be provisioned in user accounts.

The particular illustrated compute service provider 500 includes a plurality of server computers 502A-502D. While only four server computers are shown, any number can be used, and large centers can include thousands of server computers. The server computers 502A-502D can provide computing resources for executing software instances 506A-506D. In one embodiment, the instances 506A-506D are virtual machines. As known in the art, a virtual machine is an instance of a software implementation of a machine (i.e. a computer) that executes applications like a physical machine. In the example of virtual machine, each of the servers 502A-502D can be configured to execute a hypervisor 508 or another type of program configured to enable the execution of multiple instances 506 on a single server. Additionally, each of the instances 506 can be configured to execute one or more applications.

It should be appreciated that although the embodiments disclosed herein are described primarily in the context of virtual machines, other types of instances can be utilized with the concepts and technologies disclosed herein. For instance, the technologies disclosed herein can be utilized with storage resources, data communications resources, and with other types of computing resources. The embodiments disclosed herein might also execute all or a portion of an application directly on a computer system without utilizing virtual machine instances.

One or more server computers 504 can be reserved for executing software components for managing the operation of the server computers 502 and the instances 506. For example, the server computer 504 can execute a management component 510. A user can access the management component 510 to configure various aspects of the operation of the instances 506 purchased by the user. For example, the user can purchase, rent or lease instances and make changes to the configuration of the instances. The user can also specify settings regarding how the purchased instances are to be scaled in response to demand. The management component can further include a policy document to implement user policies. An auto scaling component 512 can scale the instances 506 based upon rules defined by the user. In one embodiment, the auto scaling component 512 allows a user to specify scale-up rules for use in determining when new instances should be instantiated and scale-down rules for use in determining when existing instances should be terminated. The auto scaling component 512 can consist of a number of subcomponents executing on different server computers 502 or other computing devices. The auto scaling component 512 can monitor available computing resources over an internal management network and modify resources available based on need.

A deployment component 514 can be used to assist users in the deployment of new instances 506 of computing resources. The deployment component can have access to account information associated with the instances, such as who is the owner of the account, credit card information, country of the owner, etc. The deployment component 514 can receive a configuration from a user that includes data describing how new instances 506 should be configured. For example, the configuration can specify one or more applications to be installed in new instances 506, provide scripts and/or other types of code to be executed for configuring new instances 506, provide cache logic specifying how an application cache should be prepared, and other types of information. The deployment component 514 can utilize the user-provided configuration and cache logic to configure, prime, and launch new instances 506. The configuration, cache logic, and other information may be specified by a user using the management component 510 or by providing this information directly to the deployment component 514. The instance manager can be considered part of the deployment component.

User account information 515 can include any desired information associated with a user or user of the multi-tenant environment. For example, the user account information can include a unique identifier for a user, a user address, billing information, licensing information, customization parameters for launching instances, scheduling information, auto-scaling parameters, previous IP addresses used to access the account, etc.

A network 530 can be utilized to interconnect the server computers 502A-502D and the server computer 504. The network 530 can be a local area network (LAN) and can be connected to a Wide Area Network (WAN) 540 so that end users can access the compute service provider 500. It should be appreciated that the network topology illustrated in FIG. 5 has been simplified and that many more networks and networking devices can be utilized to interconnect the various computing systems disclosed herein.

A central server computer 550 that can control dynamic remapping is coupled to the local area network. In one example, the central server computer 550 can decide to replace a switch on the upstream fabric 152 (FIG. 1). In such a case, the central server computer 550 can transmit a request to the switch 110 to re-route traffic using port pairing. For example, in FIG. 3, the CPU 310 can control the layer 1 hardware block 361 to switch ports so that network traffic is not passed to the switch being replaced. As a result, port-to-port routing can be controlled by the network device itself, by the central server computer 550 or by a host server computer coupled to the network device that is actively transmitting packets through the network device (e.g., using the rail ID 170, FIG. 1).

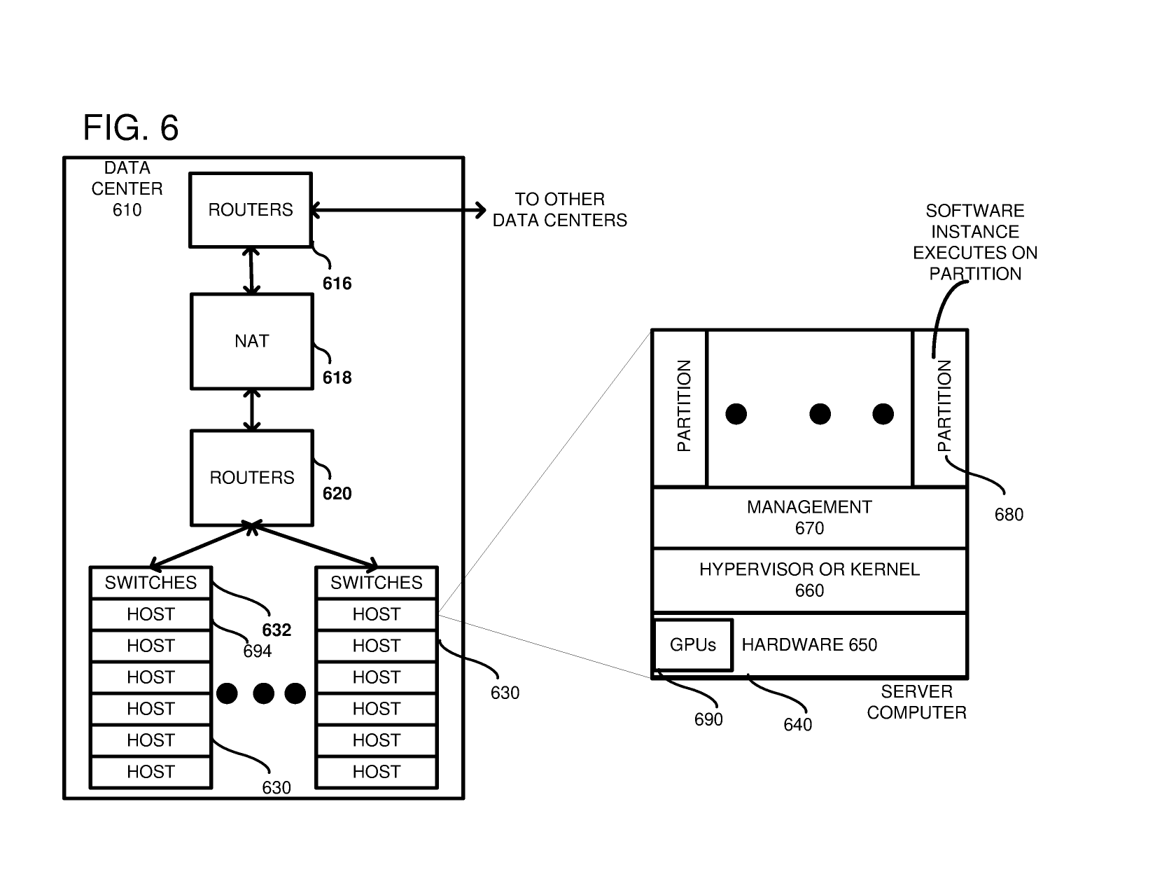

FIG. 6 illustrates a data center 610 and the physical hardware associated therewith. The data center 610 can be coupled to a plurality of other data centers, such as by routers 616. The routers 616 read address information in a received packet and determine the packet’s destination. If the router decides that a different data center contains a host server computer, then the packet is forwarded to that data center. If the packet is addressed to a host in the data center 610, then it is passed to a network address translator (NAT) 618 that converts the packet’s public IP address to a private IP address. The NAT also translates private addresses to public addresses that are bound outside of the datacenter 610. Additional routers 620 can be coupled to the NAT to route packets to one or more racks of host server computers 630. Each rack 630 can include a switch 632 coupled to multiple host server computers. The switch 630 at the top of the rack can be the switch 110 (FIG. 1). A particular host server computer is shown in an expanded view at 640.

Each host 640 has underlying hardware 650 including one or more CPUs, memory, storage devices, etc. In addition, a GPU 690 can be at the hardware layer 650. The GPU 690 can be one of the GPUs 140 of FIG. 1. In one example, the GPU 690 can be a GPU 0 (FIG. 1) and the host 694 can have a corresponding GPU 0. Both GPU 0’s can communicate through the routers 620 using rail 0 as shown in FIG. 1. Consequently, high-speed communication can occur between host server computers 630 on different racks without ECMP switching. Running a layer above the hardware 650 is a hypervisor or kernel layer 660. The hypervisor or kernel layer can be classified as a type 1 or type 2 hypervisor. A type 1 hypervisor runs directly on the host hardware 650 to control the hardware and to manage the guest operating systems. A type 2 hypervisor runs within a conventional operating system environment. Thus, in a type 2 environment, the hypervisor can be a distinct layer running above the operating system and the operating system interacts with the system hardware. Different types of hypervisors include Xen-based, Hyper-V, ESXi/ESX, Linux, etc., but other hypervisors can be used. A management layer 670 can be part of the hypervisor or separated therefrom and generally includes device drivers needed for accessing the hardware 650. The partitions 680 are logical units of isolation by the hypervisor. Each partition 680 can be allocated its own portion of the hardware layer’s memory, CPU allocation, storage, etc. Additionally, each partition can include a virtual machine and its own guest operating system. As such, each partition is an abstract portion of capacity designed to support its own virtual machine independent of the other partitions.

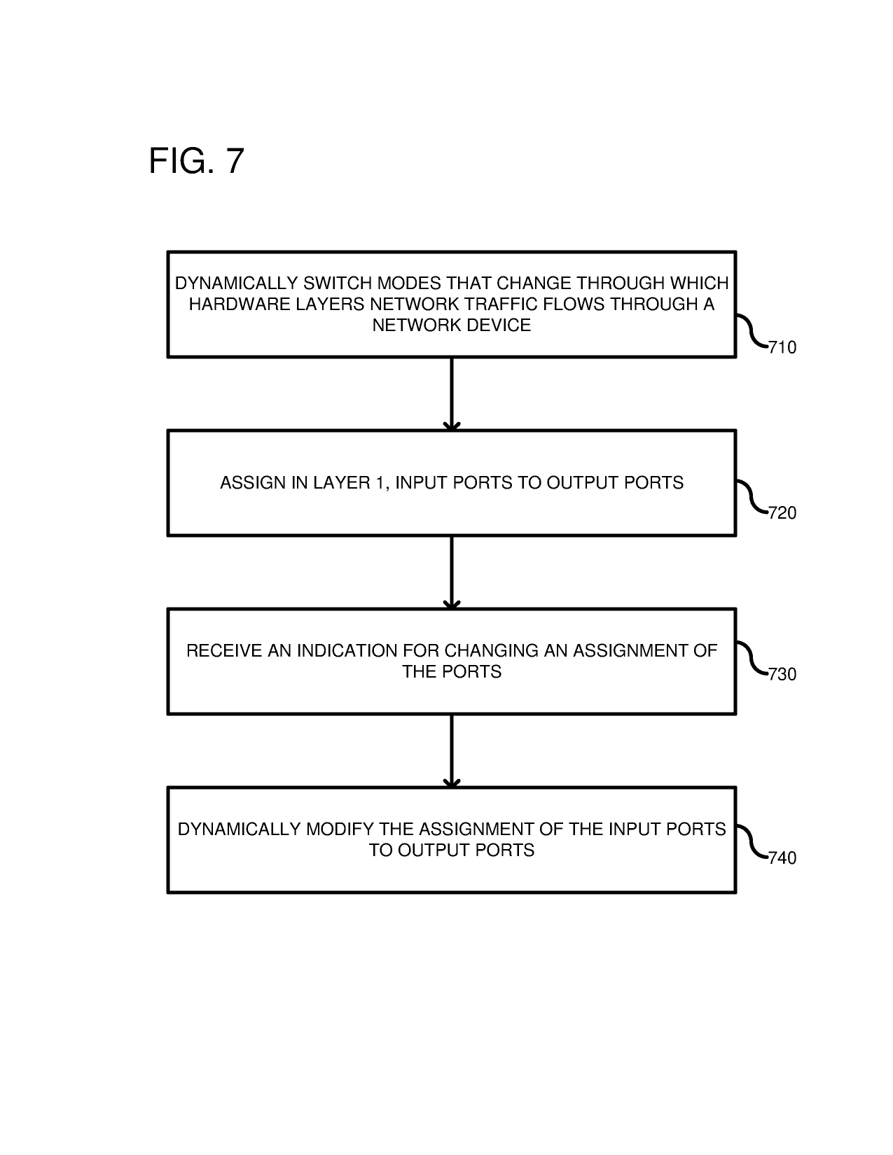

FIG. 7 is a flowchart according to another embodiment for dynamically changing a forwarding behavior of a network device. In process block 710, a switch dynamically switches modes, which changes the hardware layers through which network traffic flows. For example, FIG. 3 shows modes 1-3 wherein different combinations of hardware blocks are used depending on the mode. In FIG. 720, in a layer 1 hardware block, input ports are assigned to output ports. For example, in FIG. 3, the layer 1 hardware block 361 can assign input port 340 to output port 342. In process block 730, an indication is received for changing an assignment of the ports. As previously explained, in FIG. 1, such an indication can be a rail ID change from a server computer coupled to the switch for network traffic communication, a monitoring daemon 360 (FIG. 3) that detects a link failure, or a central server 550 (FIG. 5) that wants to perform maintenance on the network. In process block 740, the assignment of the input ports to the output ports can be dynamically modified, such as is shown in FIG. 2 at 228.

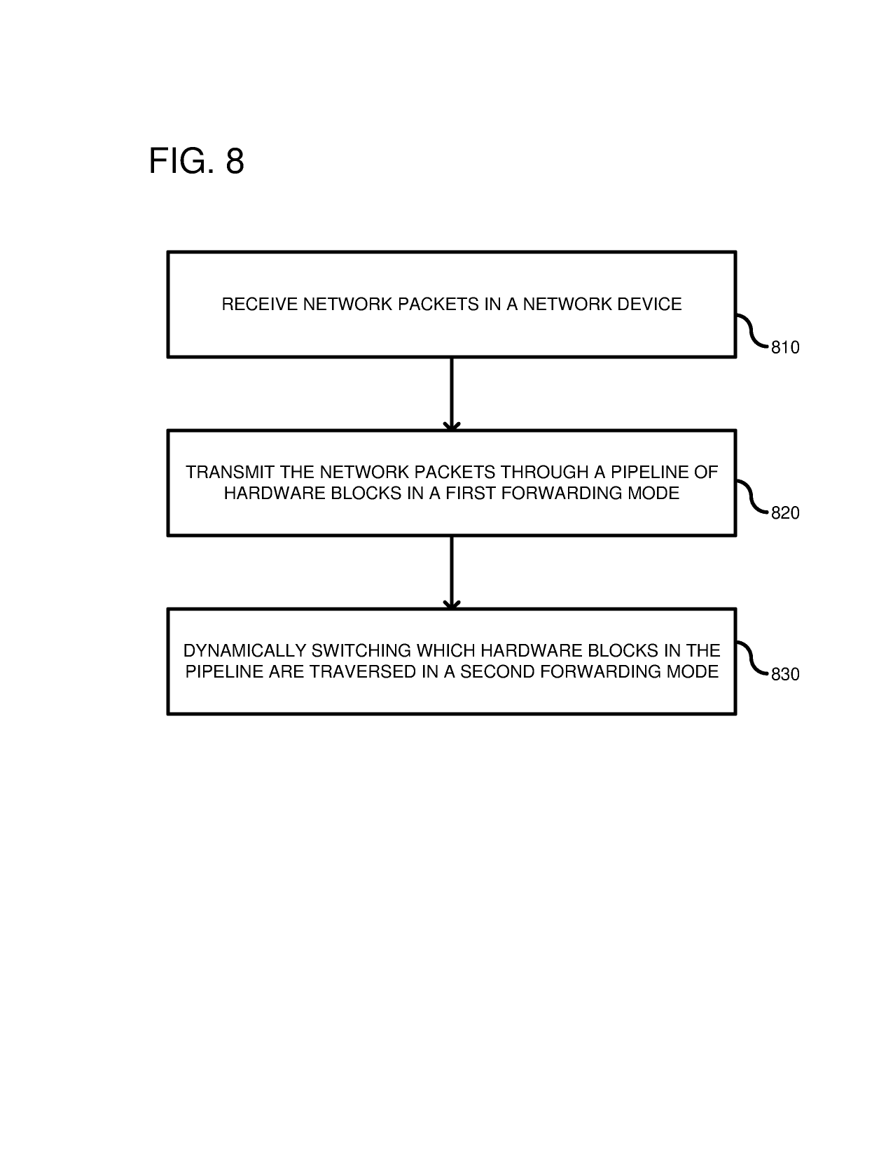

FIG. 8 is a flowchart according to another embodiment for dynamically changing forwarding behavior of a network device. In process block 810, network packets are received in a network device. For example, in FIG. 3, network packets can be received on the input port 340. In process block 820, network packets are transmitted through a pipeline of hardware blocks in a first forwarding mode. For example, in FIG. 3, the network packets can be transmitted in mode 2 through layer 2 hardware and layer 3 hardware. In process block 830, which hardware blocks are traversed in the pipeline is dynamically switched to a second forwarding mode. For example, in FIG. 3, the network device 300 can be switched into mode 3, wherein only the layer 1 hardware block is used. Thus, without powering off the network device, without rebooting and without human intervention (e.g., through a User Interface), the network device can change forwarding modes while network traffic is being transmitted through the network device. The dynamic switching can be controlled by the parser by parsing a header in network packets and switching modes in real-time based upon the header. In one example, the parser can change the mode based upon reachability specific destinations. For example, the switching can be based upon which port can be used to reach a destination or use ECMP to broadcast to all ports.

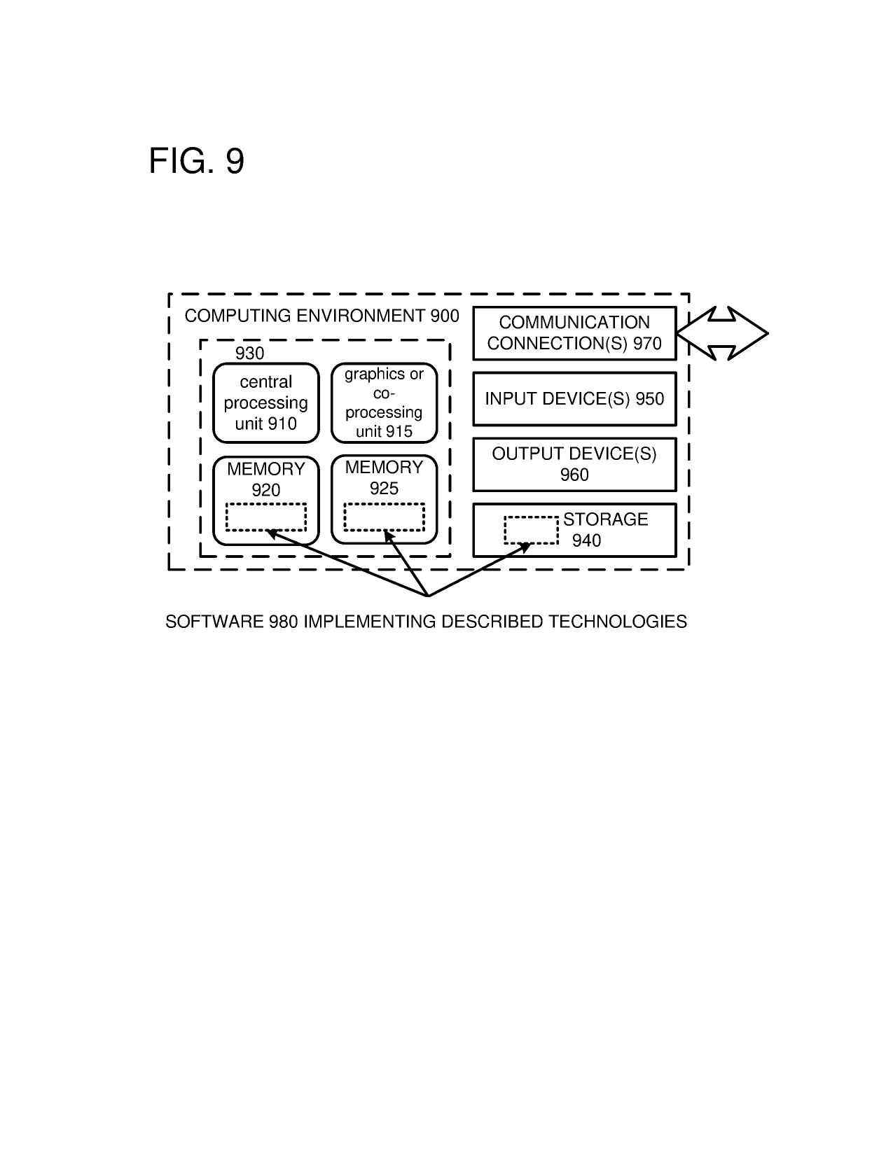

FIG. 9 depicts a generalized example of a suitable computing environment 900 in which the described innovations may be implemented. The computing environment 900 is not intended to suggest any limitation as to scope of use or functionality, as the innovations may be implemented in diverse general-purpose or special-purpose computing systems. For example, the computing environment 900 can be any of a variety of computing devices (e.g., desktop computer, laptop computer, server computer, tablet computer, etc.)

With reference to FIG. 9, the computing environment 900 includes one or more processing units 910, 915 and memory 920, 925. In FIG. 9, this basic configuration 930 is included within a dashed line. The processing units 910, 915 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, etc.), or some combination of the two, accessible by the processing unit(s). The memory 920, 925 stores software 980 implementing one or more innovations described herein, in the form of computer-executable instructions suitable for execution by the processing unit(s). For example, the computing environment 900 can be used for the central server computer 550.

A computing system may have additional features. For example, the computing environment 900 includes storage 940, one or more input devices 950, one or more output devices 960, and one or more communication connections 970. An interconnection mechanism (not shown) such as a bus, controller, or network interconnects the components of the computing environment 900. Typically, operating system software (not shown) provides an operating environment for other software executing in the computing environment 900, and coordinates activities of the components of the computing environment 900.

The tangible storage 940 may be removable or non-removable, and includes magnetic disks, magnetic tapes or cassettes, CD-ROMs, DVDs, or any other medium which can be used to store information in a non-transitory way and which can be accessed within the computing environment 900. The storage 940 stores instructions for the software 980 implementing one or more innovations described herein.

The input device(s) 950 may be a touch input device such as a keyboard, mouse, pen, or trackball, a voice input device, a scanning device, or another device that provides input to the computing environment 900. The output device(s) 960 may be a display, printer, speaker, CD-writer, or another device that provides output from the computing environment 900.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java, Perl, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only examples of the invention and should not be taken as limiting the scope of the invention. We therefore claim as our invention all that comes within the scope of these claims.

What is claimed is:

1. A method of forwarding traffic through a network device, the method comprising:
in a network device having hardware layers including a layer 1 hardware, a layer 2 hardware, and a layer 3 hardware, dynamically switching among modes that change through which of the hardware layers network traffic flows;
assigning, when operating in a layer 1 mode that uses the layer 1 hardware, input ports to output ports, wherein the network traffic bypasses the layer 2 hardware and the layer 3 hardware;
receiving an indication for changing the assignment of the input ports to the output ports; and
in response to the indication, dynamically modifying the assignment of the input ports to the output ports through the layer 1 hardware.

2. The method of claim 1, wherein the indication is a link failure for a link coupled to either the input ports or the output ports, and wherein the dynamic modification of the assignment is performed to avoid the link failure.

3. The method of claim 1, wherein the indication is a request from a host server computer, which transmits network traffic through the network device, to change the assignment.

4. The method of claim 1, wherein the indication is a request from a central server computer to change the assignment to perform maintenance on a network fabric upstream of the network device.

5. The method of claim 1, further comprising receiving a command to switch modes and switching from the layer 1 mode, wherein the network traffic passes only through layer 1 hardware, to a layer 3 mode, wherein network traffic passes through at least layer 2 hardware and layer 3 hardware.

6. One or more computer-readable media comprising computer-executable instructions that, when executed, cause a computing system to perform a method comprising:
receiving network packets in a network device;
transmitting the network packets through a pipeline of hardware blocks in a first forwarding mode; and
parsing headers of the network packets and based upon the parsing, dynamically switching which hardware blocks in the pipeline are traversed in a second forwarding mode, wherein different ones of the hardware blocks are traversed in the second forwarding mode than in the first forwarding mode.

7. The one or more computer-readable media of claim 6, wherein the dynamic switching occurs without powering off or rebooting the network device or without human intervention.

8. The one or more computer-readable media of claim 6, wherein the pipeline of hardware blocks includes a layer 1 hardware block, a layer 2 hardware block, and a layer 3 hardware block and wherein the dynamic switching is based upon reachability specific destinations.

9. The one or more computer-readable media of claim 8, wherein the network packets are transmitted through the layer 2 hardware block and the layer 3 hardware block in the first forwarding mode, and wherein the network packets are transmitted through the layer 1 hardware block in the second forwarding mode.

10. The one or more computer-readable media of claim 6, wherein in the second forwarding mode, the network packets are transmitted through a layer 1 hardware block without passing through a layer 2 hardware block or a layer 3 hardware block, and wherein the layer 1 hardware block assigns an input port of the network device to an output port of the network device.

11. The one or more computer-readable media of claim 10, wherein the method further includes dynamically changing the assignment of which input port is coupled to which output port.

12. The one or more computer-readable media of claim 6, wherein a server computer is coupled to the network device and transmits the network packets, and wherein the method includes transmitting a control message from the server computer to the network device to change which forwarding mode to use based upon a destination.

13. The one or more computer-readable media of claim 11, wherein the method further includes detecting a link failure associated with the input port or the output port, and wherein the dynamic changing of the assignment is due to the detection of the link failure.

14. The one or more computer-readable media of claim 6, wherein the method further includes detecting a protocol used by the network packets, and wherein the dynamic switching depends upon the protocol.

15. A network device, comprising:
input ports for receiving network traffic and output ports for forwarding the network traffic;
a pipeline of hardware blocks coupled between the input and output ports, the pipeline including: a parser, a layer 1 hardware block, a layer 2 hardware block, and a layer 3 hardware block; and
a forwarding mode switch coupled to the pipeline for dynamically modifying the pipeline by selectively choosing which of the hardware blocks are used to process network packets.

16. The network device of claim 15, wherein the layer 1 hardware block couples one of the input ports to one of the output ports, and the layer 1 block is dynamically configurable to change which of the input ports is coupled to which of the output ports while the network device transmits network packets.

17. The network device of claim 15, wherein the layer 3 hardware includes a Forwarding Information Base (FIB) to choose which of the output ports to transmit a network packet.

18. The network device of claim 15, wherein the network device is a router or a switch.

19. The network device of claim 15, wherein the pipeline further includes a parser prior to the layer 2 hardware block.

20. The network device of claim 15, further including a processor configured to receive link failure information and to reconfigure the layer 1 hardware in response thereto.
